(19) United States
(12) Patent Application Publication
(10) Pub. No.: US 2009/0114745 A1
(43) Pub. Date: May 7, 2009

(54) SYSTEMS AND METHODS FOR SELECTIVELY MODULATING WATER PRESSURE AT A FAUCET

(76) Inventor: Michael Elliott, Salt Lake, UT (US)

Correspondence Address: David B. Tingey, 1800 Eagle Gate Tower, 60 East South Temple, Salt Lake City, UT, 84145, US

(21) Appl. No.: 12/260,789

(22) Filed: Oct. 29, 2008

Related U.S. Application Data
(60) Provisional application No. 60/984,143, filed on Oct. 31, 2007.

(51) Int. Cl. B05B 1/00

(52) U.S. Cl. 239/600; 137/13

(57) ABSTRACT

Systems and methods for selectively providing greatly increased water pressure from a sink faucet for use. A water pressure modulating device is placed in a fluid stream to reduce the cross-sectional area of the stream and to increase the velocity of the fluid flow. The pressure modulating device can be integrally formed in a faucet or can be coupled to a faucet. When the water pressure modulating device is in use, the user can open the valve of the faucet and the water pressure modulating device causes water to flow with increased pressure from the spout. The increased water pressure has proved beneficial for a variety of uses.

### CROSS-REFERENCE TO RELATED APPLICATION

This application claims the benefit of U.S. Provisional Patent Application No. 60/984,143, filed Oct. 31, 2007, the entire disclosure of which is hereby incorporated by reference.

### BACKGROUND OF THE INVENTION

1. Field of the Invention

The present invention relates to modulating water pressure at a faucet. In particular, the present invention relates to systems and methods for selectively providing greatly increased water pressure from a sink faucet for use.

2. Background and Related Art

Indoor plumbing techniques include the use of a faucet that is used to provide water to a sink or basin. A faucet can be connected to a cold water line and/or to a hot water line. Many faucets include a handle and a spout. The handle allows a user to establish an amount of water that flows from the spout. The water is shut off when the handle is placed in a position that completely closes a valve of the faucet. Adjusting the handle to allow for a small opening in the valve allows for water to flow. The maximum amount of water flow occurs when the handle is placed in a position to fully open the valve.

While such faucets are currently available, problems exist. For example, once a handle is positioned to allow water to flow from the spout, the user must remember to reposition the handle to a position that closes the valve in order to stop the water from flowing from the spout. In an attempt to address such a problem, some faucets include a handle that when released is automatically repositioned to close the valve. Other faucets include an infrared proximity sensor that determines when the water flows from the faucet. When the sensor is triggered, water flows from the spout of the faucet. However, despite the particular type of faucet employed to allow water to flow, users are often limited to the water pressure dispensed from the spout.

Thus, while techniques currently exist that are used to dispense water from a faucet, challenges still exist. Accordingly, it would be an improvement in the art to augment or even replace current techniques with other techniques.

### SUMMARY OF THE INVENTION

The present invention relates to modulating water pressure from a faucet. In particular, the present invention relates to systems and methods for selectively providing greatly increased water pressure from a sink faucet for use.

Implementation of the present invention takes place in association with a water pressure modulating device that is placed in a fluid stream to reduce the cross-sectional area of the stream and to increase the velocity of the fluid flow. The pressure modulating device can be integrally formed in a faucet or can be selectively coupled to and uncoupled from a faucet.

In at least one implementation, a water pressure modulating device includes a body having a first surface with an aperture and a wall extending from the first surface and forming a spout-receiving portion that is configured to receive and couple to a faucet spout. In a further implementation, a securing mechanism is used to maintain the spout receiving portion coupled to the faucet spout.

A user of a sink faucet can selectively couple a water pressure modulating device onto a spout of a sink faucet. When coupled, the user can open the valve of the faucet and the water pressure modulating device causes water to flow with increased pressure from the spout. The increased water pressure has proved beneficial for a variety of uses, including for cleaning and removing debris from razors, toothbrushes, dentures, dishes, utensils, fingernails, toenails, and other objects.

While the described methods and devices have proven to be particularly useful in association with sink faucets, those skilled in the art can appreciate that the methods and devices can be used in a variety of different applications to yield greatly increased fluid pressure (e.g., water pressure). By way of example, the water pressure modulating device may be used in association with a bathtub faucet, a spigot, or another suitable water source.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative faucet having a valve in a closed position;

FIG. 2 illustrates a representative faucet having a valve in an open position to allow water to flow;

FIG. 3 illustrates a representative manner for coupling a water pressure modulating device in accordance with a representative embodiment of the present invention;

FIG. 4 illustrates a representative water pressure modulating device coupled to a representative faucet having a valve in a closed position;

FIG. 5 illustrates a representative water pressure modulating device coupled to a faucet having a valve in an open position, wherein the device provides increased water pressure from the faucet;

FIG. 6 illustrates a perspective view of a representative embodiment of a water pressure modulating device;

FIG. 7A illustrates a top planar view of a representative water pressure modulating device in accordance with an embodiment of the present invention;

FIG. 7B illustrates a bottom planar view of a representative water pressure modulating device in accordance with an embodiment of the present invention;

FIG. 8 illustrates a cross-sectional view of a representative embodiment of a water pressure modulating device;

FIG. 9 illustrates a cross-sectional view of a representative embodiment of a water pressure modulating device;

FIG. 10 shows a side view of a representative embodiment of a water pressure modulating device;

FIG. 11A shows a top view of a representative embodiment of a water pressure modulating device;

FIG. 11B shows a cross-sectional view of a representative embodiment of a water pressure modulating device;

FIG. 12 shows another representative embodiment of the present invention, wherein a representative water pressure modulating device is in a disengaged position; and

FIG. 13 illustrates another representative embodiment of the present invention, wherein a representative water pressure modulating device is in an engaging position to provide increased water pressure from the faucet.

### DETAILED DESCRIPTION OF THE INVENTION

The present invention relates to modulating water pressure from a faucet. In particular, the present invention relates to systems and methods for selectively providing greatly increased water pressure from a sink faucet for use.

Embodiments of the present invention take place in association with a water pressure modulating device that is placed in a fluid stream to reduce the cross-sectional area of the stream and to increase the velocity of the fluid flow. The pressure modulating device can be integrally formed with a faucet or can be selectively coupled to a faucet.

In at least one embodiment, the water pressure modulating device includes a body having a first surface with an aperture and a wall extending from the first surface and forming a spout-receiving portion that is configured to receive and couple to a faucet spout. In a further embodiment, a securing mechanism is used to maintain the spout receiving portion coupled to the faucet spout.

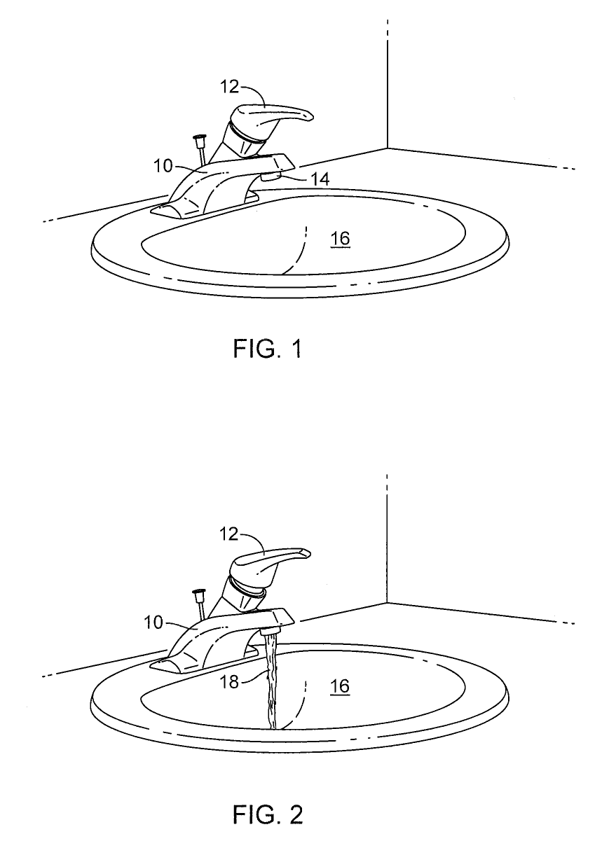

While the water pressure modulating device can be use with virtually any suitable faucet, FIG. 1 shows a representative embodiment of a suitable faucet 10 that comprises handle 12 and spout 14. Although not shown, faucet 10 further includes a valve that when in a closed position prevents water from flowing from spout 14 and into basin 16.

As illustrated in FIG. 2, when handle 12 is positioned so as to open the valve (not shown) of faucet 10, water 18 flows from spout 14 and into basin 16. To stop the water flow from spout 14, handle 12 is repositioned so as to close the valve (not shown).

In accordance with embodiments of the present invention, the water pressure modulating device is selectively used to increase the pressure of water flowing from a faucet. By way of example, a user of a faucet can selectively couple the water pressure modulating device onto a spout of a faucet. When coupled, the user can open the valve of the faucet and allow the water pressure modulating device to cause water to flow with increased pressure from the spout. The increased water pressure has proven to be beneficial for a variety of uses, including for the cleaning and/or removing debris from razors, dishes, utensils, dentures, toothbrushes, tools, toenails, fingernails, and other objects.

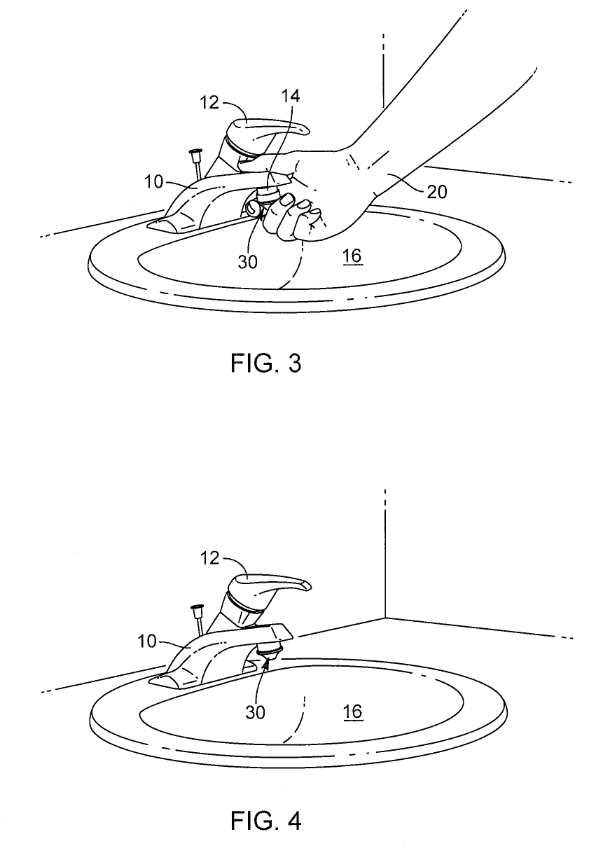

FIG. 3 depicts a representative manner for coupling the water pressure modulating device to a faucet in accordance with at least one embodiment. In FIG. 3, faucet 10 includes handle 12 and spout 14. User 20 selectively couples water pressure modulating device 30 to faucet 10. More particularly, in the illustrated embodiment, spout 14 is inserted into a receiving portion of water pressure modulating device 30, which provides a bias onto an outer wall of spout 14.

FIG. 4 illustrates water pressure modulating device 30 installed onto the spout of faucet 10. In some embodiments, when device 30 is installed, it reduces and/or eliminates water from dripping from faucet 10. Moreover, when device 30 is installed, a user can open the valve of faucet 10 and allow water pressure modulating device 30 to cause water to flow with increased pressure from the spout.

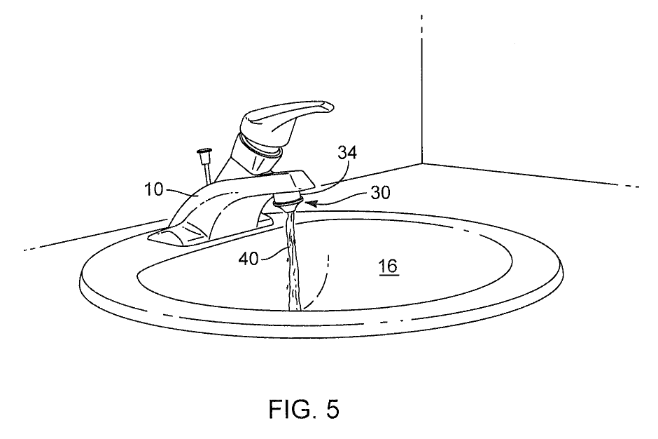

One such example is illustrated in FIG. 5, wherein water pressure modulating device 30 is illustrated as being coupled to a faucet 10 having a valve in an open position, and wherein device 30 provides increased water pressure 40 from faucet 10. When device 30 is coupled, the user can open the valve of faucet 10 and water pressure modulating device 30 causes water to flow with increased pressure from the spout of faucet 10. More particularly, water pressure modulating device 30 is placed in a fluid stream of the water to reduce the cross-sectional area of the stream and to increase the velocity of the water flow. The increased water pressure has proved beneficial for a variety of uses.

Embodiments of the present invention embrace a water pressure modulating device that comprises a body with a first surface defining an aperture there through. In such embodiments, the device can have any characteristic or component that allows it to reduce the cross-sectional area of a water stream and to increase the velocity of the water stream that flows from a faucet.

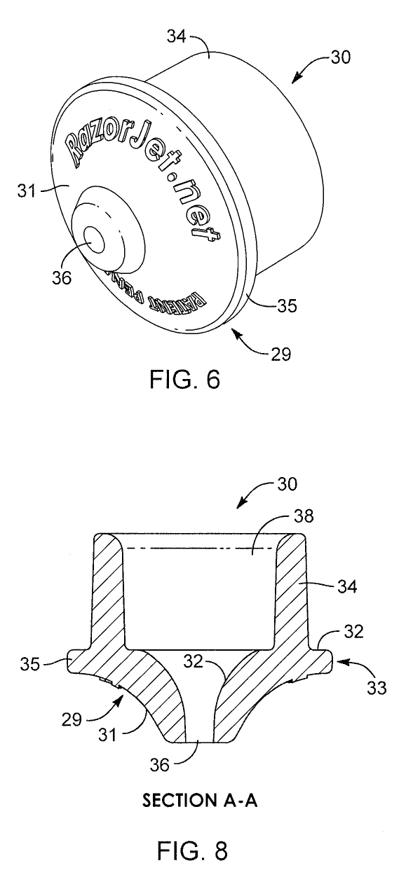

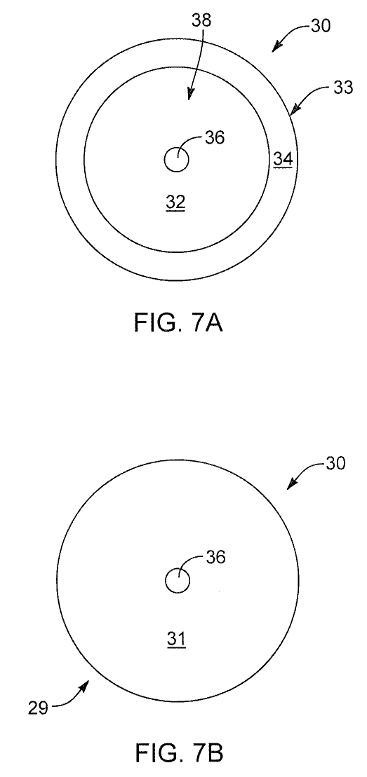

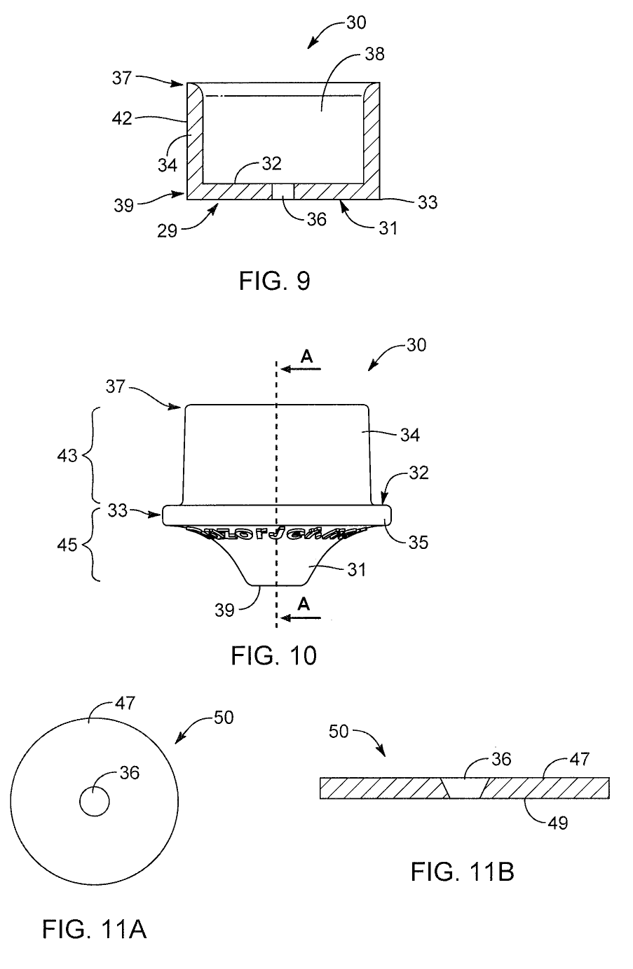

According to some embodiments, the body of water pressure modulating device comprises a first surface from which one or more walls extend. By way of illustration, FIGS. 6 through 9 show embodiments of device 30 wherein the body 29 comprises a first surface 32 and a second surface 31. In such embodiments, FIGS. 6 through 9 show wall 34 extends from first surface 32 of device 30. Such a wall can serve several purposes. In one example, wall 34 works in conjunction with first surface 32 to direct water from the spout through aperture 36. In another example, wall 34 is configured to work with first surface 32 to form a spout-receiving portion 38 that is configured to receive and couple with at least a portion a faucet spout.

Where the water pressure modulating device comprises walls that extend from the first surface of the device, the device can have any characteristic that is compatible with its intended purposes. In one example, the walls can extend from any desired portion of the first surface that allows the device to receive and couple with at least a portion of a faucet spout. For instance, FIGS. 7A, 7B, and 9 show some embodiments where wall 34 extends from the circumference 33 of first surface 32. In other instances, however, FIGS. 8 and 10 show some embodiments where wall 34 is disposed inside of and coaxially with circumference 33. In such instances, the portion of first surface 32 that extends past wall 34 forms a gripping ring 35. Gripping ring 35 can serve many purposes, including acting as a contact surface for the user to grasp when coupling and decoupling device 30 from a faucet.

In another example of a suitable characteristic of device 30 that has wall 34 extending from first surface 32, wall 34 and first surface 32 of body 29 can be connected to each other in any suitable manner. Indeed, in some instances, FIGS. 8 and 9 show that wall 34 and first surface 32 are integrally formed as a single piece. In another example (not illustrated), wall 34 and surface 32 are configured to be selectively attached and detached from one another. Indeed, in some instances, wall 34 and surface 32 are threadingly attached, frictionally attached, mechanically attached, or otherwise attached to each other so as to be selectively detachable from each other.

In still another example, the outer surface of device 30, which as FIG. 10 shows may extend from a first end 37 to a second end 39 of device 30, can have any suitable shape, including being substantially cylindrical, conical, tapered, funnel-shaped, combinations thereof, and so forth. For instance, FIG. 9 shows a representative embodiment where an outer surface 42 of device 30 is substantially cylindrical between its first 37 and second 39 end. In other instances, FIG. 10 illustrates a representative embodiment where device 30 comprises a cylindrical portion 43 that extends from first end 37 to first surface 32. FIG. 10 further depicts that device 30 comprises a tapered portion 45 that extends from first surface 32 to second end 39.

In yet another example, first surface 32 can have any shape that allows water to pass from the faucet spout through aperture 36. For instance, FIG. 9 shows a representative embodiment where first surface 32 is substantially planar. In another instance, however, FIG. 8 shows a representative embodiment in which first surface 32 is funnel-shaped so as to direct water through aperture 36.

According to some embodiments, the water pressure modulating device comprises a disc with an aperture extending through the disc to allow a fluid to pass there through. In such embodiments, the disc can have any characteristic that allows it to reduce the cross-sectional area of a fluid stream and to increase the velocity of the fluid stream that flows from a faucet. By way of example, the disc can be any suitable shape that allows it to be used to force water through the aperture and to increase the velocity of water flowing from a spout. By way of illustration FIGS. 11A and 11B show representative embodiments of device 50 in which device 50 comprises a first substantially planar surface 47 and a second substantially planar second surface 49. Additionally, as shown in FIG. 11B, first planar surface 47 runs substantially parallel to second planar surface 49.

The aperture of the water pressure modulating device can comprise any characteristic that allows the device to increase the pressure and velocity of water, or any other suitable fluid, flowing from a faucet. For example, the aperture can have any cross-sectional area that is smaller than the cross sectional area of the spout of a faucet. In another example, FIG. 9 shows some embodiments where aperture 36 has a substantially constant width throughout its length, which extends between first surface 32 and second surface 31. In still another example, FIG. 11B shows some embodiments wherein at least a portion of aperture 36 is tapered between first surface 47 and second surface 49.

When the water pressure modulating device (e.g., device 30 and 50) is selectively coupled to a faucet, the device can be selectively secured to the faucet through the use of a securing mechanism. Some examples of such securing mechanisms include one or more biased retaining surfaces, pivot joints, clips, levers, switches, clamps, straps, or other mechanisms that act to retain the water pressure modulating device coupled to the faucet in a manner that allows water flowing from the faucet to flow with an increased velocity.

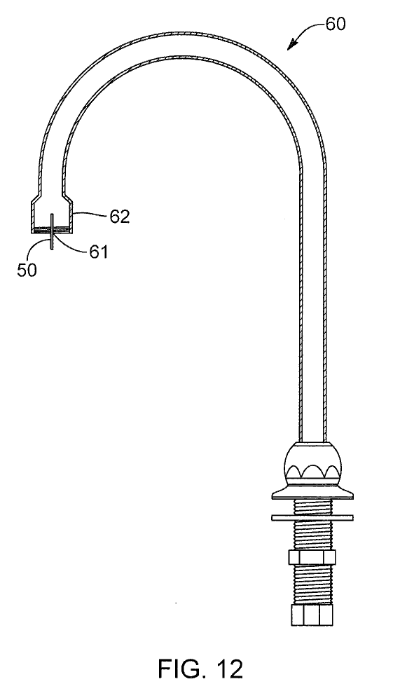

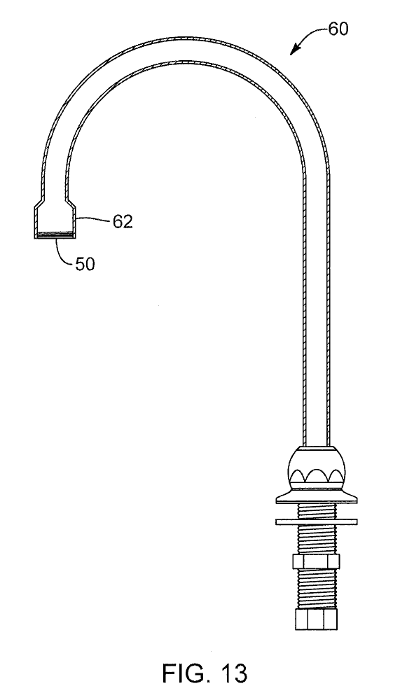

In one example of a securing mechanism, FIG. 5 shows a representative embodiment in which wall 34 is biased so as to retain device 30 on the spout of faucet 10. In another example, FIGS. 12 and 13 show some embodiments where device 50 is pivotably coupled to faucet 60. The device can be pivotally connected to a faucet in any suitable manner. In some instances (not illustrated), device 50 is pivotally attached to a faucet so as to pivot about a perimeter of the disc. In other instances, FIG. 12 shows device 50 is pivotally connected to faucet 60 at the point of the disc's maximum diameter 61. In such instances, FIGS. 12 and 13 show device 50 can be selectively transitioned between a non-engaged position (FIG. 12) and an engaged position (FIG. 13) in which device 50 is fitted on faucet 60 so to force water from the spout to pass through the aperture of the device.

The water pressure modulating device can be made of any suitable material. Indeed, in some embodiments, the device comprises a compliant material, such as rubber, a polymer material, or other compliant material. For instance, wall 34 may comprise a compliant material that is adapted to bias wall 34 against a spout. However, other embodiments of the present invention embrace a water pressure modulating device comprising a non-compliant material, such as a metal, a non-compliant polymer material, or another non-compliant material. In still other embodiments, the device comprises a non-compliant material that is used in association with a compliant material. For instance, while wall 34 may comprise a compliant material that serves to bias and couple wall 34 to a spout, the first surface 32 and aperture 36 may comprise non-compliant material, such as a metal.

In addition to the aforementioned components and characteristics, the water pressure modulating device can have any other component or characteristic that allows it to fulfill its intended purposes. In one example, the device comprises a gasket or other sealing mechanism that is placed between the device and the spout to create a seal between the two and force water through the aperture.

In another example, some embodiments of the device comprise an aperture in which the size of the aperture is selectively adjustable. Such an aperture enables a user to selectively increase or decrease water pressure through the device by decreasing or increasing the size of the aperture. While the aperture's diameter size can be adjusted in any suitable manner, in some cases, the aperture comprises one or more adjustable fins that are moveable to occlude more or less of the aperture.

In still another example, in some embodiments the water pressure modulating device is incorporated into a faucet such that the device is not selectively releasable from the faucet. In such embodiments, the device is employed by passing water from the faucet through the device when an elevated pressure is desired.

Thus, as discussed herein, embodiments of the present invention embrace modulating water pressure from a faucet. In particular, the present invention relates to systems and methods for selectively providing greatly increased water pressure from a sink faucet for use.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A water pressure modulating device comprising:
a body defining an aperture; and
a wall extending from said body, wherein said body and said wall define a spout-receiving portion that is configured to be selectively coupled to a faucet spout, wherein said spout-receiving portion provides a bias on said spout, and wherein a cross-sectional area of said aperture is smaller than a cross-sectional area of said spout.

2. The device of claim 1, wherein said body and said wall are integrally formed as a single piece.

3. The device of claim 1, wherein said water pressure modulating device comprises a securing mechanism.

4. The device of claim 1, wherein said aperture has a substantially constant width throughout its length.

5. The device of claim 1, wherein said aperture is tapered in at least a portion of its length.

6. The device of claim 1, wherein said wall extends from a first surface of said body, and wherein said first surface comprises a substantially planar surface.

7. The device of claim 1, wherein said wall extends from a first surface of said body, and wherein said first surface comprises a substantially funnel-shaped surface.

8. The device of claim 1, further comprises a gripping ring that extends past said wall.

9. The device of claim 1, wherein said device further comprises an outer surface that is substantially cylindrical between a first end and a second end.

10. The device of claim 1, wherein said device comprises an outer surface comprising a portion that is substantially cylindrical between a first end and a first surface of said body, and a second surface is that is substantially tapered from said first surface to a second end of said device.

11. A method of providing increased water pressure from a faucet spout, the method comprising:
providing a faucet that is coupled to a water source;
coupling a water pressure modulating device to a spout of said faucet, wherein said water pressure modulating device comprises:
a body having an aperture; and
a wall extending from said body, wherein said body and said wall define a spout-receiving portion that is configured to be selectively coupled to said spout, wherein said spout-receiving portion provides a bias on said spout, and wherein a cross-sectional area of said aperture is smaller than a cross-sectional area of said spout;
causing water to flow from said water source and through said aperture; and
using said water pressure modulating device to restrict a flow of said water and to increase a velocity of said flow.

12. The method of claim 11, wherein said body and said wall are integrally formed as a single piece.

13. The method of claim 11, wherein said aperture is tapered in at least a portion of its length.

14. The method of claim 11, wherein said wall extends from a first surface of said body, and wherein said first surface comprises a substantially planar surface.

15. The method of claim 11, wherein said wall extends from a first surface of said body, and wherein said first surface comprises a substantially funnel-shaped surface.

16. The method of claim 11, wherein said aperture has a substantially constant width throughout its length.

17. The method of claim 11, further comprising using the increased velocity of said flow to remove debris from an object.

18. A water pressure modulating device comprising:
a body having a second surface and a first surface that is adapted to engage a spout of a faucet,
wherein said first surface and said second surface define an aperture having a cross-sectional area that is smaller than a cross-sectional area of said spout, and
wherein said body is movable between a disengaged position and an engaged position, which is adapted to force water through said aperture and to increase a velocity of said water.

19. The device of claim 18, wherein said body is pivotally connected to said faucet so as to pivot about a perimeter of said body.

20. The device of claim 16, wherein said body is pivotally connected to said faucet so as to pivot about a point of maximum diameter of said body.
